(19) United States
(12) Patent Application Publication
(10) Pub. No.: US 2026/0351105 A1
(43) Pub. Date: Nov. 5, 2026

(54) METHOD AND SYSTEM FOR DETECTING WEARING POSTURE OF WEARABLE SMART DEVICE, DEVICE, STORAGE MEDIUM, AND COMPUTER PROGRAM PRODUCT

(71) Applicant: Kiwear, Inc., Dover, DE (US)

(72) Inventor: Chi Shi, Shanghai (CN)

(21) Appl. No.: 19/287,445

(22) Filed: Jul. 31, 2025

(30) Foreign Application Priority Data
Apr. 30, 2025 (CN) 202510570573.6

(51) Int. Cl. G08B 21/04; H04B 1/3827

(52) U.S. Cl. CPC G08B 21/0446; H04B 1/385; H04B 2001/3861

(57) ABSTRACT

A method and a system for detecting a wearing posture of a wearable smart device, a device, a storage medium, and a computer program product are provided. The method includes: triggering an interaction action event in the wearable smart device; obtaining motion information of the wearable smart device; obtaining a wearing direction of the wearable smart device based on the motion information, where the wearing direction includes a forward direction or a reverse direction; obtaining a wearing angle of the wearable smart device based on the motion information, where the wearing angle is a rotation angle of the wearable smart device based on a standard position; and performing interaction recognition based on the wearing direction and the wearing angle. The present invention facilitates improvement in accuracy of interaction recognition and application flexibility of the wearable smart device.

This application claims the priority to Chinese Patent Application 202510570573.6, filed on Apr. 30, 2025, the entire disclosure of which is incorporated herein by reference.

### TECHNICAL FIELD

Embodiments of the present invention relate to the field of pose tracking technologies, and in particular, to a method and a system for detecting a wearing posture of a wearable smart device, a device, a storage medium, and a computer program product.

### BACKGROUND

With the development of wearable smart devices, users pursue more convenient and diverse interaction modes. Finger action-based interaction becomes a popular trend due to its rich interaction types and desirable user experience. The finger action-based interaction is usually classified through a deep learning model.

A smart ring is an emerging category in the field of wearable smart devices, which grows rapidly in recent years due to its wearing comfort, accurate health monitoring, and stylish design.

### SUMMARY

A problem to be solved in embodiments of the present invention is to provide a method and a system for detecting a wearing posture of a wearable smart device, a device, a storage medium, and a computer program product, to facilitate improvement in accuracy of interaction recognition and application flexibility of the wearable smart device.

To solve the foregoing problem, an embodiment of the present invention provides a method for detecting a wearing posture of a wearable smart device, including: triggering an interaction action event in the wearable smart device; obtaining motion information of the wearable smart device; obtaining a wearing direction of the wearable smart device based on the motion information, where the wearing direction includes a forward direction or a reverse direction; obtaining a wearing angle of the wearable smart device based on the motion information, where the wearing angle is a rotation angle of the wearable smart device based on a standard position; and performing interaction recognition based on the wearing direction and the wearing angle.

Optionally, during the obtaining motion information of the wearable smart device, the motion information includes one or more of angular velocity information, acceleration information, or gravity information.

Optionally, the obtaining motion information of the wearable smart device includes: obtaining the motion information of the wearable smart device through an inertial measurement unit (IMU).

Optionally, the obtaining a wearing direction of the wearable smart device based on the motion information includes: establishing a wearing direction classification model, where the wearing direction classification model includes a mapping relationship between a motion information and a wearing direction; and obtaining the wearing direction corresponding to the motion information through the wearing direction classification model.

Optionally, the establishing a wearing direction classification model includes: collecting motion information of the wearable smart device as forward motion information when the wearing direction is the forward direction; collecting motion information of the wearable smart device as reverse motion information when the wearing direction is the reverse direction; and establishing the wearing direction classification model through the forward motion information and the reverse motion information.

Optionally, the forward motion information and the reverse motion information are trained through a deep learning model, to establish the wearing direction classification model.

Optionally, the obtaining a wearing direction of the wearable smart device based on the motion information includes: marking a forward area and a reverse area of the wearable smart device, where the forward area and the reverse area are respectively located on two opposite sides of the wearable smart device; analyzing the motion information to obtain an instantaneous center of motion of the wearable smart device; obtaining the forward direction as the wearing direction of the wearable smart device when the instantaneous center of motion is located in the forward area of the wearable smart device; and obtaining the reverse direction as the wearing direction of the wearable smart device when the instantaneous center of motion is located in the reverse area of the wearable smart device.

Optionally, the marking a forward area and a reverse area of the wearable smart device includes: obtaining, based on a motion coordinate system of the wearable smart device, an area where a positive direction of the motion coordinate system is located as the forward area, and obtaining an area where a negative direction of the motion coordinate system is located as the reverse area.

Optionally, the obtaining a wearing angle of the wearable smart device based on the motion information includes: marking a standard pose state of the wearable smart device at a standard position; obtaining a pose state of the wearable smart device based on the motion information; and obtaining the rotation angle of the wearable smart device based on the standard position in combination with the pose state of the wearable smart device and the standard pose state.

Optionally, the marking a standard pose state of the wearable smart device at a standard position includes: collecting motion information of the wearable smart device at the standard position as standard motion information; and obtaining the pose state of the wearable smart device as the standard pose state based on the standard motion information.

Optionally, the performing interaction recognition based on the wearing direction and the wearing angle includes: determining whether the wearable smart device is worn abnormally based on the wearing direction and the wearing angle; transmitting a calibration instruction when the wearable smart device is worn abnormally; performing the interaction recognition after the calibration instruction is transmitted; and performing the interaction recognition when the wearable smart device is not worn abnormally.

Optionally, during the determining whether the wearable smart device is worn abnormally based on the wearing direction and the wearing angle, when the wearing direction is the reverse direction and/or when the wearing angle is greater than a preset angle, the wearable smart device is worn abnormally; or otherwise, the wearable smart device is worn normally.

Optionally, the calibration instruction is transmitted through a text message and/or a voice message.

Optionally, the performing interaction recognition based on the wearing direction and the wearing angle includes: preprocessing the motion information based on the wearing direction and the wearing angle, to convert the motion information into preprocessed motion information in a standard wearing state; and performing the interaction recognition based on the preprocessed motion information.

Optionally, during the preprocessing the motion information based on the wearing direction and the wearing angle, to convert the motion information into preprocessed motion information in a standard wearable state, the standard wearing state is a wearing state in which the wearing direction is the forward direction and the wearing angle is less than or equal to a preset angle.

Optionally, the wearable device includes a smart ring, the smart ring is configured to be worn on a finger of a user, a surface of the smart ring includes a touch area, and the touch area has an operating direction; when the operating direction is toward a root of the finger of the user, a wearing direction of the smart ring is the forward direction, and when the operating direction is toward a fingertip of the finger of the user, the wearing direction of the smart ring is the reverse direction; and when the touch area is located at a preset position of the finger of the user, the smart ring is at the standard position.

Correspondingly, an embodiment of the present invention further provides a system for detecting a wearing posture of a wearable smart device, including: a trigger component, configured to trigger an interaction action event in the wearable smart device; a motion information obtaining component, configured to obtain motion information of the wearable smart device; a wearing direction obtaining component, configured to obtain a wearing direction of the wearable smart device based on the motion information, where the wearing direction includes a forward direction or a reverse direction; a wearing angle obtaining component, configured to obtain a wearing angle of the wearable smart device based on the motion information, where the wearing angle is a rotation angle of the wearable smart device based on a standard position; and an interaction recognition component, configured to perform interaction recognition based on the wearing direction and the wearing angle.

Correspondingly, an embodiment of the present invention further provides a device, including at least one memory and at least one processor, where the memory stores one or more computer instructions, and the one or more computer instructions are executed by the processor to implement the method for detecting a wearing posture of a wearable smart device provided in the embodiments of the present invention.

Correspondingly, an embodiment of the present invention further provides a storage medium, storing one or more computer instructions, where the one or more computer instructions are used to implement the method for detecting a wearing posture of a wearable smart device provided in the embodiments of the present invention.

Correspondingly, an embodiment of the present invention further provides a computer program product, including a computer program/instruction, where the computer program/instruction, when executed by a processor, is used to implement the method for detecting a wearing posture of a wearable smart device provided in the embodiments of the present invention.

Compared with the prior art, the technical solutions of the embodiments of the present invention have the following advantages:

In the method for detecting a wearing posture of a wearable smart device provided in the embodiments of the present invention, the wearing direction of the wearable smart device is obtained based on the motion information, where the wearing direction includes the forward direction or the reverse direction; the wearing angle of the wearable smart device is obtained based on the motion information, where and the wearing angle is the rotation angle of the wearable smart device based on the standard position, and the interaction recognition is performed based on the wearing direction and the wearing angle. In the embodiments of the present invention, the wearing direction and the wearing angle are obtained based on the motion information of the wearable smart device, so that wearing calibration may be implemented based on the wearing direction and the wearing angle, thereby guiding a user for accurate wearing to perform relatively accurate interaction recognition. Alternatively, the wearing direction and the wearing angle of a user may not be limited. When a user cannot adjust a wearing state, interaction recognition is performed based on the wearing direction and the wearing angle, which facilitates improvement in accuracy of the interaction recognition, and brings convenience to the user in some special scenarios, thereby improving application flexibility of the wearable smart device.

### BRIEF DESCRIPTION OF THE DRAWINGS

FIG. 1 is a flowchart of an embodiment of a method for detecting a wearing posture of a wearable smart device according to the present invention.

FIG. 2 to FIG. 4 are schematic diagrams of a wearable smart device and a wearing mode in an embodiment of a method for detecting a wearing posture of a wearable smart device according to the present invention.

FIG. 5 is a functional block diagram of an embodiment of a system for detecting a wearing posture of a wearable smart device according to the present invention.

FIG. 6 is a hardware structure diagram of an embodiment of a device according to the present invention.

### DETAILED DESCRIPTION

It may be learned from the background that many wearable smart devices perform action control interaction with a user by using inertial measurement unit (IMU) data. The wearable smart devices may further have a key or a slide touchpad for users to manipulate. To correctly use these wearable smart devices, the users need to wear these wearable smart devices in a correct wearing direction at a correct wearing angle, to perform interaction recognition.

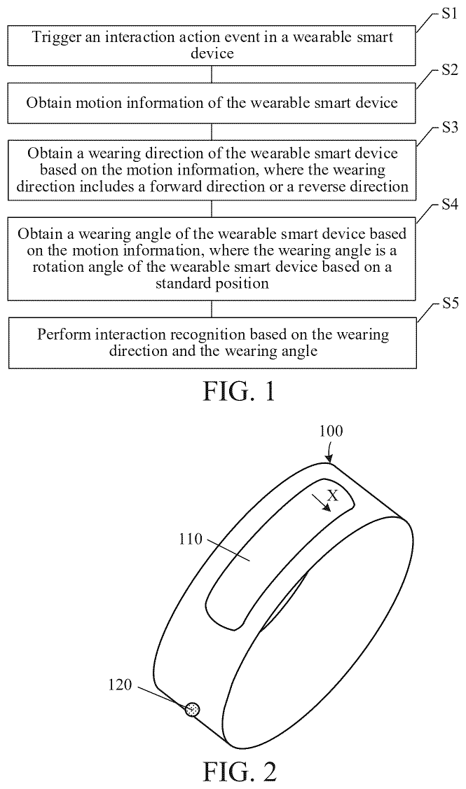

To solve the foregoing technical problem, an embodiment of the present invention provides a method for detecting a wearing posture of a wearable smart device. FIG. 1 is a flowchart of an embodiment of a method for detecting a wearing posture of a wearable smart device according to the present invention.

Referring to FIG. 1, the method for detecting a wearing posture of a wearable smart device includes the following basic steps:
Step S1: Trigger an interaction action event in the wearable smart device.
Step S2: Obtain motion information of the wearable smart device.
Step S3: Obtain a wearing direction of the wearable smart device based on the motion information, where the wearing direction includes a forward direction or a reverse direction.
Step S4: Obtain a wearing angle of the wearable smart device based on the motion information, where the wearing angle is a rotation angle of the wearable smart device based on a standard position.
Step S5: Perform interaction recognition based on the wearing direction and the wearing angle.

In the embodiments of the present invention, the wearing direction and the wearing angle are obtained based on the motion information of the wearable smart device, so that wearing calibration may be implemented based on the wearing direction and the wearing angle, thereby guiding a user for accurate wearing to perform relatively accurate interaction recognition. Alternatively, the wearing direction and the wearing angle of a user may not be limited. When a user cannot adjust a wearing state, interaction recognition is performed based on the wearing direction and the wearing angle, which facilitates improvement in accuracy of the interaction recognition, and brings convenience to the user in some special scenarios, thereby improving application flexibility of the wearable smart device.

In order to make the foregoing objectives, features, and advantages of the embodiments of the present invention more apparent and easier to understand, the specific embodiments of the present invention are described in detail below with reference to FIG. 2 to FIG. 4.

The detection method in this embodiment is used for performing interaction recognition when a user wears a wearable smart device and generates an interaction action.

In this embodiment, the wearable device includes a smart ring 100. The smart ring 100 is configured to be worn on a finger 200 of a user. A surface of the smart ring 100 includes a touch area 110, and the touch area 110 has an operating direction (for example, a direction X shown in FIG. 2).

The smart ring 100 is a wearable smart device like a finger ring, and has a built-in independent power supply and a data collection apparatus. The smart ring may be worn on the finger 200 of the user, and can perform data communication with another smart device, and perform interaction recognition with the user.

As an example, in this embodiment, the smart ring 100 is configured to be worn on an index finger of the user. When wearing the smart ring 100, the user performs an operation in the touch area 110 through a thumb.

The touch area 110 is configured to be touched by a user for sense. The operating direction is a direction in which the user performs an operation in the touch area 110. For example, the operating direction is a touch and slide direction, or the operating direction is a text display direction, or an upper key and a lower key of the touch area 110 match an upper portion and a lower portion of a space when the operation is performed in the operating direction.

Specifically, in this embodiment, the touch area 110 includes a touch screen.

Step S1 of triggering an interaction action event in the wearable smart device is performed.

When the user wears the wearable smart device, the wearable device receives a wearing signal, which triggers the interaction action event in the wearable smart device, to detect a subsequent wearing posture.

As an example, in this embodiment, the smart ring 100 is worn on the finger 200 of the user, and the interaction action event is triggered in the smart ring 100.

Step S2 of obtaining motion information of the wearable smart device is performed.

The motion information of the wearable smart device is obtained to detect a wearing posture.

In this embodiment, during the obtaining motion information of the wearable smart device, the motion information includes one or more of angular velocity information, acceleration information, or gravity information.

The angular velocity information, the acceleration information, and the gravity information can represent a posture and a motion state of an interaction action.

In this embodiment, the obtaining motion information of the wearable smart device includes: obtaining the motion information of the wearable smart device through an IMU.

Specifically, in this embodiment, the IMU is built in the wearable smart device, and the motion information of the wearable smart device is obtained by collecting inertial measurement data thorough the IMU.

Step S3 of obtaining a wearing direction of the wearable smart device based on the motion information is performed, where the wearing direction includes a forward direction or a reverse direction.

After wearing the wearable smart device, the user performs gesture control interaction or performs an operation on the wearable smart device. When the wearing direction is the forward direction, the wearing direction is a direction that facilitates interaction or operation by the user, and when the wearing direction is the reverse direction, the wearing direction is a direction that impedes interaction or operation by the user.

As an example, in this embodiment, when the operating direction is toward a root of the finger of the user (for example, an area B shown in FIG. 4), it is convenient for the user to perform an operation in the touch area 110. Correspondingly, a wearing direction of the smart ring 100 is the forward direction. When the operating direction is toward a fingertip of the finger of the user (for example, an area A shown in FIG. 4), it is inconvenient for the user to perform an operation in the touch area 110. Correspondingly, the wearing direction of the smart ring 100 is the reverse direction.

Two embodiments of specific steps of obtaining the wearing direction of the wearable smart device based on motion information are respectively described below.

A detailed description of a first embodiment is as follows.

In this embodiment, the obtaining a wearing direction of the wearable smart device based on the motion information includes: establishing a wearing direction classification model, where the wearing direction classification model includes a mapping relationship between a motion information and a wearing direction.

The wearing direction classification model is configured to determine the wearing direction based on the motion information, and the wearing direction classification model includes the mapping relationship between motion information and a wearing direction. Specifically, the wearing direction classification model includes a mapping relationship between the wearing direction being the forward direction and motion information when the wearing direction is the forward direction, and the wearing direction classification model further includes a mapping relationship between the wearing direction being the reverse direction and motion information when the wearing direction is the reverse direction.

In this embodiment, the establishing a wearing direction classification model includes: collecting motion information of the wearable smart device as forward motion information when the wearing direction is the forward direction; and collecting motion information of the wearable smart device as reverse motion information when the wearing direction is the reverse direction.

The forward motion information and the reverse motion information of the wearable smart device are respectively collected, to perform model training.

Specifically, in this embodiment, IMU data when the wearing direction of the smart ring 100 is a forward wearing posture and a reverse wearing posture is collected thorough the IMU, and the two types of IMU data are respectively correspondingly marked as a forward direction and a reverse direction.

Correspondingly, in this embodiment, the wearing direction classification model is established through the forward motion information and the reverse motion information.

In this embodiment, the forward motion information and the reverse motion information are trained through a deep learning model to establish the wearing direction classification model.

The deep learning model is a complex mathematical model based on an artificial neural network that has a strong feature learning capability and can process complex data, which facilitates a relatively good prediction capability for motion information data collected in real time after a large amount of forward motion information and reverse motion information are trained.

In this embodiment, the wearing direction corresponding to the motion information is obtained through the wearing direction classification model.

Specifically, IMU data during movement of the wearable smart device is inputted into the wearing direction classification model, and the wearing direction classification model determines and outputs a wearing direction of a current wearing posture being the forward direction or the reverse direction.

A detailed description of a second embodiment is as follows.

In this embodiment, the obtaining a wearing direction of the wearable smart device based on the motion information includes: marking a forward area and a reverse area of the wearable smart device, where the forward area and the reverse area are respectively located on two opposite sides of the wearable smart device.

The forward area and the reverse area of the wearable smart device are marked for subsequently detecting the wearing direction of the wearable smart device. The forward area and the reverse area are respectively located on the two opposite sides of the wearable smart device. Namely, the forward area and the reverse area are respectively located in spaces on the two opposite sides of the wearable smart device.

As an example, in this embodiment, a space on a side of the root of the finger of the user of the smart ring 100 is a forward area, and a space on a side of the fingertip of the finger of the user of the smart ring 100 is a reverse area.

In this embodiment, the marking a forward area and a reverse area of a wearable smart device includes: obtaining, based on a motion coordinate system of the wearable smart device, an area where a positive direction of the motion coordinate system is located as the forward area, and obtaining an area where a negative direction of the motion coordinate system is located as the reverse area.

The motion coordinate system of the wearable smart device refers to a coordinate system in the wearable smart device for data analysis of the motion information. Correspondingly, the area where the positive direction of the motion coordinate system is located is obtained as the positive area, and the area where the negative direction of the motion coordinate system is located is obtained as the negative area.

In this embodiment, the motion information is analyzed to obtain an instantaneous center of motion of the wearable smart device.

Data of the motion information collected by the wearable smart device all has a direction. Therefore, the instantaneous center of motion falls in different areas in the motion coordinate system of the wearable smart device based on different motion directions, and an area where the instantaneous center of motion is located can represent a motion direction of the wearable smart device in the motion coordinate system.

Specifically, in this embodiment, the instantaneous center of motion of the wearable smart device is calculated based on a relationship between an acceleration and an angular velocity.

Correspondingly, in this embodiment, the forward direction is obtained as the wearing direction of the wearable smart device when the instantaneous center of motion is located in the forward area of the wearable smart device; and the reverse direction is obtained as the wearing direction of the wearable smart device when the instantaneous center of motion is located in the reverse area of the wearable smart device.

As an example, in this embodiment, when the instantaneous center calculated through the motion information collected by the smart ring 100 falls in the area on the side of the root of the finger of the user of the smart ring 100, a current wearing direction is the forward direction, and when the instantaneous center calculated through the motion information collected by the smart ring 100 falls in the area on the side of the fingertip of the user of the smart ring 100, the current wearing direction is the reverse direction.

Step S4 of obtaining a wearing angle of the wearable smart device based on the motion information, is performed, where the wearing angle is a rotation angle of the wearable smart device based on a standard position.

After wearing the wearable smart device, the user performs gesture control interaction or performs an operation on the wearable smart device. When the wearing posture is at a standard position, the wearing posture is a set wearing posture that is most beneficial to an operation of the user. A rotation angle of the wearable smart device based on the standard position refers to an angle between a current position and a start position. For any point on the wearable smart device as a reference point, the start position is the standard position of the wearable smart device, and the current position is a position of the reference point in a current wearing posture of the wearable smart device.

As an example, in this embodiment, when the touch area 110 is located at a preset position of the finger 200 of the user, the smart ring 100 is at the standard position.

Specifically, the smart ring 100 may be rotated on the finger 200 of the user, to a position at which the touch area 110 is located at an upper half position of a side of the finger 200 of the user facing the user, which is set as the standard position.

In this embodiment, the smart ring 100 is further provided with a signal light 120 below the touch area 110. Correspondingly, when the signal light 120 is provided at a finger pulp position of the finger 200 of the user, the wearing posture of the smart ring 100 is at the standard position.

In this embodiment, the obtaining a wearing angle of the wearable smart device based on the motion information includes: marking a standard pose state of the wearable smart device at a standard position.

The standard pose state of the wearable smart device at the standard position is pre-marked, to calculate the wearing angle of the wearable smart device in real time based on the standard pose state.

Specifically, in this embodiment, the pose state refers to a state of independent rotation about three axes in three degrees of freedom (DOF).

In this embodiment, the marking a standard pose state of the wearable smart device at a standard position includes: collecting motion information of the wearable smart device at the standard position as standard motion information.

The standard motion information is collected to generate the standard pose state of the wearable smart device.

In this embodiment, the pose state of the wearable smart device is obtained as the standard pose state based on the standard motion information.

In another embodiment, the standard pose state of the wearable smart device at the standard position may be directly marked in the wearable smart device.

In this embodiment, the pose state of the wearable smart device is obtained based on the motion information.

A current pose state of the current wearable smart device is obtained based on motion information during current wearing.

In this embodiment, the rotation angle of the wearable smart device based on the standard position is obtained in combination with the pose state of the wearable smart device and the standard pose state.

Specifically, an angle of deviation of the current wearing posture of the wearable smart device from the standard position deviation is calculated in combination with the current pose state and the standard pose state.

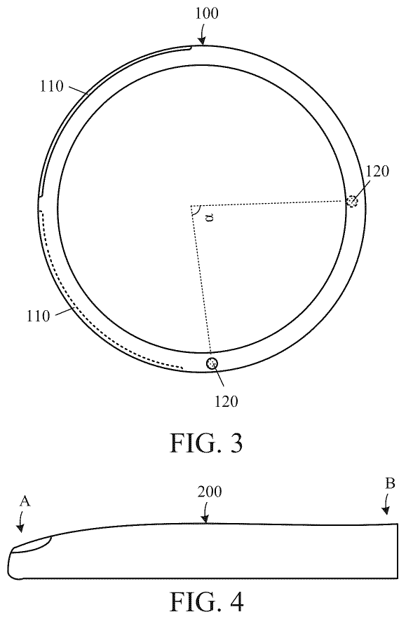

In an example, as shown in FIG. 3, in this embodiment, when the smart ring 100 is at the standard position, the touch area 110 and the signal light 120 are at solid line positions, and when the current smart ring 100 is at the current wearing position, the touch area 110 and the signal light 120 are at dashed line positions. Correspondingly, a rotation angle α of the smart ring 100 based on the standard position is obtained through calculation.

Step S5 of performing interaction recognition based on the wearing direction and the wearing angle is performed.

In this embodiment of the present invention, the wearing direction and the wearing angle are obtained based on the motion information of the wearable smart device, so that wearing calibration may be implemented based on the wearing direction and the wearing angle, thereby guiding a user for accurate wearing to perform relatively accurate interaction recognition. Alternatively, the wearing direction and the wearing angle of a user may not be limited. When a user cannot adjust a wearing state, interaction recognition is performed based on the wearing direction and the wearing angle, which facilitates improvement in accuracy of the interaction recognition, and brings convenience to the user in some special scenarios, thereby improving application flexibility of the wearable smart device.

Two embodiments of specific steps of performing interaction recognition based on the wearing direction and the wearing angle are respectively described in detail below.

A detailed description of a first embodiment is as follows.

In this embodiment, the performing interaction recognition based on the wearing direction and the wearing angle includes: determining whether the wearable smart device is worn abnormally based on the wearing direction and the wearing angle.

Specifically, when the wearing direction of the wearable smart device is the forward direction and the wearing angle of the wearable smart device facilitates operation by the user, it is considered that the wearable smart device is not worn abnormally, or otherwise, the wearable smart device is worn abnormally.

Correspondingly, in this embodiment, during the determining whether the wearable smart device is worn abnormally based on the wearing direction and the wearing angle, when the wearing direction is the reverse direction and/or when the wearing angle is greater than a preset angle, the wearable smart device is worn abnormally; or otherwise, the wearable smart device is worn normally.

It is configured that rotation of the wearable smart device rotates within a preset angle based on the standard position generates no adverse impact on operation by the user. Therefore, when the wearing angle is greater than the preset angle, the wearable smart device is worn abnormally.

In this embodiment, a calibration instruction is transmitted when the wearable smart device is worn abnormally.

The calibration instruction is transmitted to prompt a user of an abnormality when the wearable smart device is worn abnormally.

In this embodiment, the calibration instruction is transmitted through a text message and/or a voice message.

Specifically, to transmit the calibration instruction, a text message may be transmitted in the display area of the wearable smart device, or a voice message may be transmitted to the user by using the wearable smart device.

As an example, in this embodiment, the wearing posture of the wearable smart device is detected in real time. Specifically, when the user wears the wearable smart device, the wearing direction and the wearing angle are detected. If a wearing abnormality is found, the user may be prompted to re-wear the wearable smart device. Alternatively, if the wearable smart device is unexpectedly rotated to another wearing position during use of the wearable smart device by the user, which causes the key or the touch area to deviate from an operable area of the user, resulting in deteriorated use experience, after it is found through automatic calibration that the wearing direction and/or the wearing angle of the wearable smart device deviates, the calibration instruction is transmitted, to prompt the user to adjust the wearable smart device to a proper wearing posture.

In this embodiment, during transmission of the calibration instruction, only an abnormality prompt may be transmitted, to prompt the user to perform event calibration, including up-down position calibration of a key, direction calibration of a mouse, shielding calibration of a key, and the like, and an instruction with specific data information for adjusting the wearing direction and/or the wearing angle may be further transmitted based on the wearing direction and the wearing angle, so as to facilitate adjustment by the user.

In this embodiment, after the calibration instruction is transmitted, interaction recognition is performed.

After the calibration instruction is transmitted, the user adjusts the wearing posture, and then performs interaction recognition, thereby facilitating improvement of accuracy of the interaction recognition of the wearable smart device.

In this embodiment, after the calibration instruction is transmitted, the user adjusts the wearing posture, and may further perform wearing posture detection, to ensure a proper and accurate wearing posture, and then perform interaction recognition.

Correspondingly, in this embodiment, when the wearable smart device is not worn abnormally, interaction recognition is performed.

A detailed description of a second embodiment is as follows.

In this embodiment, the performing interaction recognition based on the wearing direction and wearing angle includes: preprocessing the motion information based on the wearing direction and the wearing angle, to convert the motion information into preprocessed motion information in a standard wearing state.

Because the motion information is preprocessed based on the wearing direction and the wearing angle to convert the motion information into the preprocessed motion information in the standard wearing state, interaction recognition may be performed through a built-in model in the standard wearing state, without requiring the user to adjust a wearing posture, thereby implementing interaction action recognition in any random wearing posture of the user.

In this embodiment, during the preprocessing the motion information based on the wearing direction and the wearing angle, to convert the motion information into preprocessed motion information in a standard wearable state, the standard wearing state is a wearing state in which the wearing direction is the forward direction and the wearing angle is less than or equal to a preset angle.

Specifically, inputted IMU data is preprocessed to be converted into IMU data information in a correct wearing posture, namely, a wearing posture in which the wearing direction is the forward direction and the wearing angle is less than or equal to the preset angle.

Correspondingly, in this embodiment, the interaction recognition is performed based on the preprocessed motion information.

Performing the interaction recognition based on the preprocessed motion information implements omni-directional and full-angle interaction action recognition on the wearable smart device.

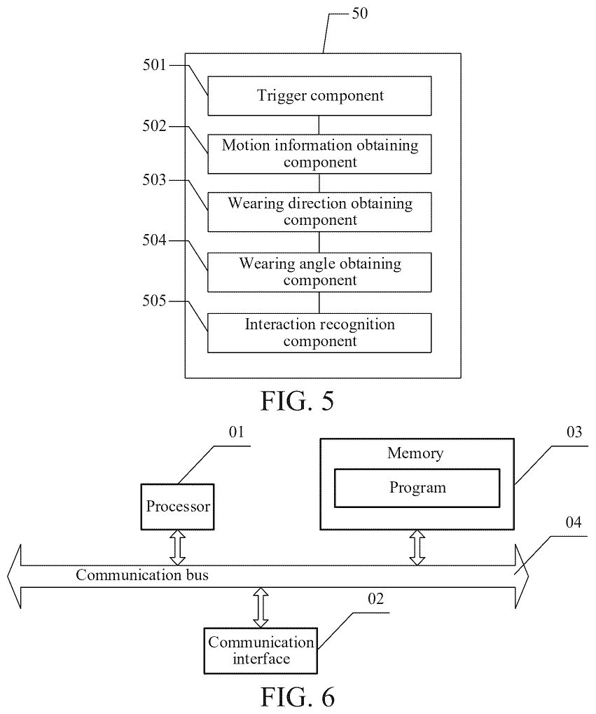

Correspondingly, the present invention further provides further provides a system for detecting a wearing posture of a wearable smart device. FIG. 5 is a functional block diagram of an embodiment of a system for detecting a wearing posture of a wearable smart device according to the present invention.

A system 50 for detecting a wearing posture of a wearable smart device includes: a trigger component 501, configured to trigger an interaction action event in the wearable smart device; a motion information obtaining component 502, configured to obtain motion information of the wearable smart device; a wearing direction obtaining component 503, configured to obtain a wearing direction of the wearable smart device based on the motion information, where the wearing direction includes a forward direction or a reverse direction; a wearing angle obtaining component 504, configured to obtain a wearing angle of the wearable smart device based on the motion information, where the wearing angle is a rotation angle of the wearable smart device based on a standard position; and an interaction recognition component 505, configured to perform interaction recognition based on the wearing direction and the wearing angle.

The detection system in this embodiment is configured to perform interaction recognition when a user wears a wearable smart device and generates an interaction action.

In this embodiment, the wearable device includes a smart ring, the smart ring is configured to be worn on a finger of a user, a surface of the smart ring includes a touch area, and the touch area has an operating direction.

The smart ring is a wearable smart device like a finger ring, and has a built-in independent power supply and a data collection apparatus. The smart ring may be worn on the finger of the user, and can perform data communication with another smart device, and perform interaction recognition with the user.

As an example, in this embodiment, the smart ring is configured to be worn on an index finger of a user. When wearing the smart ring, the user performs an operation in the touch area through a thumb.

The touch area is configured to be touched by a user for sense. The operating direction is a direction in which the user performs an operation in the touch area. For example, the operating direction is a touch and slide direction, or the operating direction is a text display direction, or an upper key and a lower key of the touch area match an upper portion and a lower portion of a space when the operation is performed in the operating direction.

Specifically, in this embodiment, the touch area includes a touch screen.

The trigger component 501 is configured to trigger an interaction action event in the wearable smart device.

When the user wears the wearable smart device, the wearable device receives a wearing signal, which triggers the interaction action event in the wearable smart device, to detect a subsequent wearing posture.

As an example, in this embodiment, the smart ring is worn on the finger of the user, and the interaction action event is triggered in the smart ring.

The motion information obtaining component 502 is configured to obtain the motion information of the wearable smart device.

The motion information of the wearable smart device is obtained to detect a wearing posture.

In this embodiment, during the obtaining motion information of the wearable smart device, the motion information includes one or more of angular velocity information, acceleration information, or gravity information.

The angular velocity information, the acceleration information, and the gravity information can represent a posture and a motion state of an interaction action.

In this embodiment, the obtaining motion information of the wearable smart device includes: obtaining the motion information of the wearable smart device through an IMU.

Specifically, in this embodiment, the IMU is built in the wearable smart device, and the motion information of the wearable smart device is obtained by collecting inertial measurement data thorough the IMU.

The wearing direction obtaining component 503 is configured to obtain the wearing direction of the wearable smart device based on the motion information, where the wearing direction includes the forward direction or the reverse direction.

After wearing the wearable smart device, the user performs gesture control interaction or performs an operation on the wearable smart device. When the wearing direction is the forward direction, the wearing direction is a direction that facilitates interaction or operation by the user, and when the wearing direction is the reverse direction, the wearing direction is a direction that impedes interaction or operation by the user.

As an example, in this embodiment, when the operating direction is toward a root of the finger of the user, it is convenient for the user to perform an operation in the touch area. Correspondingly, a wearing direction of the smart ring is the forward direction. When the operating direction is toward a fingertip of the finger of the user, it is inconvenient for the user to perform an operation in the touch area. Correspondingly, the wearing direction of the smart ring is the reverse direction.

Two embodiments of specific steps of obtaining the wearing direction of the wearable smart device based on motion information are respectively described below.

A detailed description of a first embodiment is as follows.

In this embodiment, the obtaining a wearing direction of the wearable smart device based on the motion information includes: establishing a wearing direction classification model, where the wearing direction classification model includes a mapping relationship between a motion information and a wearing direction.

The wearing direction classification model is configured to determine the wearing direction based on the motion information, and the wearing direction classification model includes the mapping relationship between motion information and a wearing direction. Specifically, the wearing direction classification model includes a mapping relationship between the wearing direction being the forward direction and motion information when the wearing direction is the forward direction, and the wearing direction classification model further includes a mapping relationship between the wearing direction being the reverse direction and motion information when the wearing direction is the reverse direction.

In this embodiment, the establishing a wearing direction classification model includes: collecting motion information of the wearable smart device as forward motion information when the wearing direction is the forward direction; and collecting motion information of the wearable smart device as reverse motion information when the wearing direction is the reverse direction.

The forward motion information and the reverse motion information of the wearable smart device are respectively collected, to perform model training.

Specifically, in this embodiment, IMU data when the wearing direction of the smart ring is a forward wearing posture and a reverse wearing posture is collected thorough the IMU, and the two types of IMU data are respectively correspondingly marked as a forward direction and a reverse direction.

Correspondingly, in this embodiment, the wearing direction classification model is established through the forward motion information and the reverse motion information.

In this embodiment, the forward motion information and the reverse motion information are trained through a deep learning model to establish the wearing direction classification model.

The deep learning model is a complex mathematical model based on an artificial neural network that has a strong feature learning capability and can process complex data, which facilitates a relatively good prediction capability for motion information data collected in real time after a large amount of forward motion information and reverse motion information are trained.

In this embodiment, the wearing direction corresponding to the motion information is obtained through the wearing direction classification model.

Specifically, IMU data during movement of the wearable smart device is inputted into the wearing direction classification model, and the wearing direction classification model determines and outputs a wearing direction of a current wearing posture being the forward direction or the reverse direction.

A detailed description of a second embodiment is as follows.

In this embodiment, the obtaining a wearing direction of the wearable smart device based on the motion information includes: marking a forward area and a reverse area of the wearable smart device, where the forward area and the reverse area are respectively located on two opposite sides of the wearable smart device.

The forward area and the reverse area of the wearable smart device are marked for subsequently detecting the wearing direction of the wearable smart device. The forward area and the reverse area are respectively located on the two opposite sides of the wearable smart device. Namely, the forward area and the reverse area are respectively located in spaces on the two opposite sides of the wearable smart device.

As an example, in this embodiment, a space on a side of the root of the finger of the user of the smart ring is a forward area, and a space on a side of the fingertip of the finger of the user of the smart ring is a reverse area.

In this embodiment, the marking a forward area and a reverse area of a wearable smart device includes: obtaining, based on a motion coordinate system of the wearable smart device, an area where a positive direction of the motion coordinate system is located as the forward area, and obtaining an area where a negative direction of the motion coordinate system is located as the reverse area.

The motion coordinate system of the wearable smart device refers to a coordinate system in the wearable smart device for data analysis of the motion information. Correspondingly, the area where the positive direction of the motion coordinate system is located is obtained as the positive area, and the area where the negative direction of the motion coordinate system is located is obtained as the negative area.

In this embodiment, the motion information is analyzed to obtain an instantaneous center of motion of the wearable smart device.

Data of the motion information collected by the wearable smart device all has a direction. Therefore, the instantaneous center of motion falls in different areas in the motion coordinate system of the wearable smart device based on different motion directions, and an area where the instantaneous center of motion is located can represent a motion direction of the wearable smart device in the motion coordinate system.

Specifically, in this embodiment, the instantaneous center of motion of the wearable smart device is calculated based on a relationship between an acceleration and an angular velocity.

Correspondingly, in this embodiment, the forward direction is obtained as the wearing direction of the wearable smart device when the instantaneous center of motion is located in the forward area of the wearable smart device; and the reverse direction is obtained as the wearing direction of the wearable smart device when the instantaneous center of motion is located in the reverse area of the wearable smart device.

As an example, in this embodiment, when the instantaneous center calculated through the motion information collected by the smart ring falls in the area on the side of the root of the finger of the user of the smart ring, a current wearing direction is the forward direction, and when the instantaneous center calculated through the motion information collected by the smart ring falls in the area on the side of the fingertip of the user of the smart ring, the current wearing direction is the reverse direction.

The wearing angle obtaining component 504 is configured to obtain the wearing angle of the wearable smart device based on the motion information, where the wearing angle is the rotation angle of the wearable smart device based on the standard position.

After wearing the wearable smart device, the user performs gesture control interaction or performs an operation on the wearable smart device. When the wearing posture is at a standard position, the wearing posture is a set wearing posture that is most beneficial to an operation of the user. A rotation angle of the wearable smart device based on the standard position refers to an angle between a current position and a start position. For any point on the wearable smart device as a reference point, the start position is the standard position of the wearable smart device, and current position is a position of the reference point in a current wearing posture of the wearable smart device.

As an example, in this embodiment, when the touch area is located at a preset position of the finger of the user, the smart ring is at the standard position.

Specifically, the smart ring may be rotated on the finger of the user, to a position at which the touch area is located at an upper half position of a side of the finger of the user facing the user, which is set as the standard position.

In this embodiment, the smart ring is further provided with a signal light below the touch area. Correspondingly, when the signal light is provided at a finger pulp position of the finger of the user, the wearing posture of the smart ring is at the standard position.

In this embodiment, the obtaining a wearing angle of the wearable smart device based on the motion information includes: marking a standard pose state of the wearable smart device at a standard position.

The standard pose state of the wearable smart device at the standard position is pre-marked, to calculate the wearing angle of the wearable smart device in real time based on the standard pose state.

Specifically, in this embodiment, the pose state refers to a state of independent rotation about three axes in three degrees of freedom (DOF).

In this embodiment, the marking a standard pose state of the wearable smart device at a standard position includes: collecting motion information of the wearable smart device at the standard position as standard motion information.

The standard motion information is collected to generate the standard pose state of the wearable smart device.

In this embodiment, the pose state of the wearable smart device is obtained as the standard pose state based on the standard motion information.

In another embodiment, the standard pose state of the wearable smart device at the standard position may be directly marked in the wearable smart device.

In this embodiment, the pose state of the wearable smart device is obtained based on the motion information.

A current pose state of the current wearable smart device is obtained based on motion information during current wearing.

In this embodiment, the rotation angle of the wearable smart device based on the standard position is obtained in combination with the pose state of the wearable smart device and the standard pose state.

Specifically, an angle of deviation of the current wearing posture of the wearable smart device from the standard position deviation is calculated in combination with the current pose state and the standard pose state.

In an example, as shown in FIG. 3, in this embodiment, when the smart ring is at the standard position, the touch area and the signal light are at solid line positions, and when the current smart ring is at the current wearing position, the touch area and the signal light are at dashed line positions. Correspondingly, a rotation angle α of the smart ring based on the standard position is obtained through calculation.

The interaction recognition component 505 is configured to perform the interaction recognition based on the wearing direction and the wearing angle.

In this embodiment of the present invention, the wearing direction and the wearing angle are obtained based on the motion information of the wearable smart device, so that wearing calibration may be implemented based on the wearing direction and the wearing angle, thereby guiding a user for accurate wearing to perform relatively accurate interaction recognition. Alternatively, the wearing direction and the wearing angle of a user may not be limited. When a user cannot adjust a wearing state, interaction recognition is performed based on the wearing direction and the wearing angle, which facilitates improvement in accuracy of the interaction recognition, and brings convenience to the user in some special scenarios, thereby improving application flexibility of the wearable smart device.

Two embodiments of specific steps of performing interaction recognition based on the wearing direction and the wearing angle are respectively described in detail below.

A detailed description of a first embodiment is as follows.

In this embodiment, the performing interaction recognition based on the wearing direction and the wearing angle includes: determining whether the wearable smart device is worn abnormally based on the wearing direction and the wearing angle.

Specifically, when the wearing direction of the wearable smart device is the forward direction and the wearing angle of the wearable smart device facilitates operation by the user, it is considered that the wearable smart device is not worn abnormally, or otherwise, the wearable smart device is worn abnormally.

Correspondingly, in this embodiment, during the determining whether the wearable smart device is worn abnormally based on the wearing direction and the wearing angle, when the wearing direction is the reverse direction and/or when the wearing angle is greater than a preset angle, the wearable smart device is worn abnormally; or otherwise, the wearable smart device is worn normally.

It is configured that rotation of the wearable smart device rotates within a preset angle based on the standard position generates no adverse impact on operation by the user. Therefore, when the wearing angle is greater than the preset angle, the wearable smart device is worn abnormally.

In this embodiment, a calibration instruction is transmitted when the wearable smart device is worn abnormally.

The calibration instruction is transmitted to prompt a user of an abnormality when the wearable smart device is worn abnormally.

In this embodiment, the calibration instruction is transmitted through a text message and/or a voice message.

Specifically, to transmit the calibration instruction, a text message may be transmitted in the display area of the wearable smart device, or a voice message may be transmitted to the user by using the wearable smart device.

As an example, in this embodiment, the wearing posture of the wearable smart device is detected in real time. Specifically, when the user wears the wearable smart device, the wearing direction and the wearing angle are detected. If a wearing abnormality is found, the user may be prompted to re-wear the wearable smart device. Alternatively, if the wearable smart device is unexpectedly rotated to another wearing position during use of the wearable smart device by the user, which causes the key or the touch area to deviate from an operable area of the user, resulting in deteriorated use experience, after it is found through automatic calibration that the wearing direction and/or the wearing angle of the wearable smart device deviates, the calibration instruction is transmitted, to prompt the user to adjust the wearable smart device to a proper wearing posture.

In this embodiment, during transmission of the calibration instruction, only an abnormality prompt may be transmitted, to prompt the user to perform event calibration, including up-down position calibration of a key, direction calibration of a mouse, shielding calibration of a key, and the like, and an instruction with specific data information for adjusting the wearing direction and/or the wearing angle may be further transmitted based on the wearing direction and the wearing angle, so as to facilitate adjustment by the user.

In this embodiment, after the calibration instruction is transmitted, interaction recognition is performed.

After the calibration instruction is transmitted, the user adjusts the wearing posture, and then performs interaction recognition, thereby facilitating improvement of accuracy of the interaction recognition of the wearable smart device.

In this embodiment, after the calibration instruction is transmitted, the user adjusts the wearing posture, and may further perform wearing posture detection, to ensure a proper and accurate wearing posture, and then perform interaction recognition.

Correspondingly, in this embodiment, when the wearable smart device is not worn abnormally, interaction recognition is performed.

A detailed description of a second embodiment is as follows.

In this embodiment, the performing interaction recognition based on the wearing direction and the wearing angle includes: preprocessing the motion information based on the wearing direction and the wearing angle, to convert the motion information into preprocessed motion information in a standard wearing state.

Because the motion information is preprocessed based on the wearing direction and the wearing angle to convert the motion information into the preprocessed motion information in the standard wearing state, interaction recognition may be performed through a built-in model in the standard wearing state, without requiring the user to adjust a wearing posture, thereby implementing interaction action recognition in any random wearing posture of the user.

In this embodiment, during the preprocessing the motion information based on the wearing direction and the wearing angle, to convert the motion information into preprocessed motion information in a standard wearable state, the standard wearing state is a wearing state in which the wearing direction is the forward direction and the wearing angle is less than or equal to a preset angle.

Specifically, inputted IMU data is preprocessed to be converted into IMU data information in a correct wearing posture, namely, a wearing posture in which the wearing direction is the forward direction and the wearing angle is less than or equal to the preset angle.

Correspondingly, in this embodiment, the interaction recognition is performed based on the preprocessed motion information.

Performing the interaction recognition based on the preprocessed motion information implements omni-directional and full-angle interaction action recognition on the wearable smart device.

An embodiment of the present invention further provides a device. The device may implement the method for detecting a wearing posture of a wearable smart device provided in the embodiments of the present invention by loading the foregoing method for detecting a wearing posture of a wearable smart device in a form of a program.

In this embodiment, the device includes a display terminal and a wearable device.

FIG. 6 is a hardware structure diagram of a device according to an embodiment of the present invention. The device in this embodiment includes at least one processor 01, at least one communication interface 02, at least one memory 03, and at least one communication bus 04.

In this embodiment, at least one processor 01, at least one communication interface 02, at least one memory 03, and at least one communication bus 04 are provided, and the processor 01, the communication interface 02, and the memory 03 complete communication with each other through the communication bus 04.

Optionally, the communication interface 02 may be an interface of a communication component configured to perform network communication, for example, an interface of a global system for mobile communications (GSM) component.

Optionally, the processor 01 may be a central processing unit (CPU), an application specific integrated circuit (ASIC), or one or more integrated circuits configured to implement the method for detecting a wearing posture of a wearable smart device described in the embodiments of the present invention.

Optionally, the memory 03 may include a high-speed random access memory (RAM), and may further include a non-volatile memory, such as at least one disk memory.

The memory 03 stores one or more computer instructions, and the one or more computer instructions are executed by the processor 01 to implement the method for detecting a wearing posture of a wearable smart device provided in the foregoing embodiments.

It is to be noted that the foregoing terminal device for implementation may further include other devices (not shown) that may not be necessary for the content disclosed in the embodiments of the present invention. Since the other devices may not be necessary for understanding the content disclosed in the embodiments of the present invention, the devices are not described one by one in the embodiments of the present invention.

An embodiment of the present invention further provides a storage medium, storing one or more computer instructions, where the one or more computer instructions are used to implement the method for detecting a wearing posture of a wearable smart device provided in the foregoing embodiments.

An embodiment of the present invention further provides a computer program product, including a computer program/instruction, where the computer program product, when executed by a processor, is used to implement the method for detecting a wearing posture of a wearable smart device provided in the foregoing embodiments.

The foregoing implementations of the present invention are a combination of elements and features of the present invention. The elements or features may be considered selective unless otherwise mentioned. Each element or feature may be practiced without being combined with other elements or features. In addition, the implementations of the present invention may be constructed by combining a part of the elements and/or features. The order of operations described in the implementations of the present invention may be rearranged. Some constructions of any implementation may be included in another implementation and may be replaced with corresponding constructions of another implementation. It is obvious to a person skilled in the art that claims in the appended claims that do not have a clear reference relationship with each other may be combined into an implementation of the present invention, or may be included as new claims in amendments after the filing of this application.

The implementations of the present invention may be implemented by various means such as hardware, firmware, software, or a combination thereof. In a hardware configuration mode, the method according to the exemplary embodiments of the present invention may be implemented by one or more ASICs, digital signal processors (DSPs), digital signal processing devices (DSPDs), programmable logic devices (PLDs), field programmable gate arrays (FPGAs), processors, controllers, microcontrollers, microprocessors, and the like.

In a firmware or software configuration mode, the implementations of the present invention may be implemented in form such as components, processes, and functions. Software code may be stored in a memory component and executed by a processor. The memory component is located inside or outside the processor, and can transmit data to and receive data from the processor by various known means.

The foregoing descriptions of the disclosed embodiments enable a person skilled in the art to implement or use the present invention. Various modifications to these embodiments are obvious to a person skilled in the art, and the general principles defined in this specification may be implemented in other embodiments without departing from the spirit or scope of the present invention. Therefore, the present invention is not limited to these embodiments illustrated herein, but conforms to the broadest scope consistent with the principles and novel features disclosed in the present invention.

Although the embodiments of the present invention are disclosed as above, the present invention is not limited thereto. A person skilled in the art may make various changes and modifications without departing from the spirit and the scope of the present invention. Therefore, the protection scope of the present invention should be subject to the scope defined by the claims.

What is claimed is:

1. A method for detecting a wearing posture of a wearable smart device, comprising:
triggering an interaction action event in the wearable smart device;
obtaining motion information of the wearable smart device;
obtaining a wearing direction of the wearable smart device based on the motion information, wherein the wearing direction comprises a forward direction or a reverse direction;
obtaining a wearing angle of the wearable smart device based on the motion information, wherein the wearing angle is a rotation angle of the wearable smart device based on a standard position; and
performing interaction recognition based on the wearing direction and the wearing angle.

2. The method for detecting a wearing posture according to claim 1, wherein during the obtaining motion information of the wearable smart device, the motion information comprises one or more of angular velocity information, acceleration information, or gravity information.

3. The method for detecting a wearing posture according to claim 1, wherein the obtaining motion information of the wearable smart device comprises: obtaining the motion information of the wearable smart device through an inertial measurement unit (IMU).

4. The method for detecting a wearing posture according to claim 1, wherein the obtaining a wearing direction of the wearable smart device based on the motion information comprises: establishing a wearing direction classification model, wherein the wearing direction classification model comprises a mapping relationship between a motion information and a wearing direction; and
obtaining the wearing direction corresponding to the motion information through the wearing direction classification model.

5. The method for detecting a wearing posture according to claim 4, wherein the establishing a wearing direction classification model comprises: collecting motion information of the wearable smart device as forward motion information when the wearing direction is the forward direction;
collecting motion information of the wearable smart device as reverse motion information when the wearing direction is the reverse direction; and
establishing the wearing direction classification model through the forward motion information and the reverse motion information.

6. The method for detecting a wearing posture according to claim 5, wherein the forward motion information and the reverse motion information are trained through a deep learning model, to establish the wearing direction classification model.

7. The method for detecting a wearing posture according to claim 1, wherein the obtaining a wearing direction of the wearable smart device based on the motion information comprises: marking a forward area and a reverse area of the wearable smart device, wherein the forward area and the reverse area are respectively located on two opposite sides of the wearable smart device;
analyzing the motion information to obtain an instantaneous center of motion of the wearable smart device;
obtaining the forward direction as the wearing direction of the wearable smart device when the instantaneous center of motion is located in the forward area of the wearable smart device; and
obtaining the reverse direction as the wearing direction of the wearable smart device when the instantaneous center of motion is located in the reverse area of the wearable smart device.

8. The method for detecting a wearing posture according to claim 7, wherein the marking a forward area and a reverse area of the wearable smart device comprises: obtaining, based on a motion coordinate system of the wearable smart device, an area where a positive direction of the motion coordinate system is located as the forward area, and obtaining an area where a negative direction of the motion coordinate system is located as the reverse area.

9. The method for detecting a wearing posture according to claim 1, wherein the obtaining a wearing angle of the wearable smart device based on the motion information comprises: marking a standard pose state of the wearable smart device at a standard position;
obtaining a pose state of the wearable smart device based on the motion information; and
obtaining the rotation angle of the wearable smart device based on the standard position in combination with the pose state of the wearable smart device and the standard pose state.

10. The method for detecting a wearing posture according to claim 9, wherein the marking a standard pose state of the wearable smart device at a standard position comprises: collecting motion information of the wearable smart device at the standard position as standard motion information; and
obtaining the pose state of the wearable smart device as the standard pose state based on the standard motion information.

11. The method for detecting a wearing posture according to claim 1, wherein the performing interaction recognition based on the wearing direction and the wearing angle comprises: determining whether the wearable smart device is worn abnormally based on the wearing direction and the wearing angle;
transmitting a calibration instruction when the wearable smart device is worn abnormally;
performing the interaction recognition after the calibration instruction is transmitted; and
performing the interaction recognition when the wearable smart device is not worn abnormally.

12. The method for detecting a wearing posture according to claim 11, wherein during the determining whether the wearable smart device is worn abnormally based on the wearing direction and the wearing angle, when the wearing direction is the reverse direction and/or when the wearing angle is greater than a preset angle, the wearable smart device is worn abnormally; or
otherwise, the wearable smart device is worn normally.

13. The method for detecting a wearing posture according to claim 11, wherein the calibration instruction is transmitted through a text message and/or a voice message.

14. The method for detecting a wearing posture according to claim 1, wherein the performing interaction recognition based on the wearing direction and the wearing angle comprises: preprocessing the motion information based on the wearing direction and the wearing angle, to convert the motion information into preprocessed motion information in a standard wearing state; and
performing the interaction recognition based on the preprocessed motion information.

15. The method for detecting a wearing posture according to claim 14, wherein during the preprocessing the motion information based on the wearing direction and the wearing angle, to convert the motion information into preprocessed motion information in a standard wearable state, the standard wearing state is a wearing state in which the wearing direction is the forward direction and the wearing angle is less than or equal to a preset angle.

16. The method for detecting a wearing posture according to claim 1, wherein the wearable device comprises a smart ring, the smart ring is configured to be worn on a finger of a user, a surface of the smart ring comprises a touch area, and the touch area has an operating direction;
when the operating direction is toward a root of the finger of the user, a wearing direction of the smart ring is the forward direction, and when the operating direction is toward a fingertip of the finger of the user, the wearing direction of the smart ring is the reverse direction; and
when the touch area is located at a preset position of the finger of the user, the smart ring is at the standard position.

17. A device, comprising at least one memory and at least one processor, wherein the memory stores one or more computer instructions, and the one or more computer instructions are executed by the processor to implement the method for detecting a wearing posture of a wearable smart device, comprising:
triggering an interaction action event in the wearable smart device;
obtaining motion information of the wearable smart device;
obtaining a wearing direction of the wearable smart device based on the motion information, wherein the wearing direction comprises a forward direction or a reverse direction;
obtaining a wearing angle of the wearable smart device based on the motion information, wherein the wearing angle is a rotation angle of the wearable smart device based on a standard position; and
performing interaction recognition based on the wearing direction and the wearing angle.

18. The device according to claim 17, wherein the obtaining a wearing direction of the wearable smart device based on the motion information comprises: establishing a wearing direction classification model, wherein the wearing direction classification model comprises a mapping relationship between a motion information and a wearing direction; and
obtaining the wearing direction corresponding to the motion information through the wearing direction classification model.

19. A storage medium, storing one or more computer instructions, wherein the one or more computer instructions are used to implement the method for detecting a wearing posture of a wearable smart device, comprising:
triggering an interaction action event in the wearable smart device;
obtaining motion information of the wearable smart device;
obtaining a wearing direction of the wearable smart device based on the motion information, wherein the wearing direction comprises a forward direction or a reverse direction;
obtaining a wearing angle of the wearable smart device based on the motion information, wherein the wearing angle is a rotation angle of the wearable smart device based on a standard position; and
performing interaction recognition based on the wearing direction and the wearing angle.

20. The storage medium according to claim 19, wherein the obtaining a wearing direction of the wearable smart device based on the motion information comprises: establishing a wearing direction classification model, wherein the wearing direction classification model comprises a mapping relationship between a motion information and a wearing direction; and
obtaining the wearing direction corresponding to the motion information through the wearing direction classification model.
